(19) United States
(12) Patent Application Publication
(10) Pub. No.: US 2012/0134156 A1
(43) Pub. Date: May 31, 2012

(54) Light-Emitting Element

(76) Inventors: Andre Paetzold, Dorsten (DE); Ralf Hitzing, Gladbeck (DE)

(21) Appl. No.: 13/386,037

(22) PCT Filed: Jul. 21, 2009
(86) PCT No.: PCT/DE09/01017

§ 371 Date: Feb. 8, 2012

(51) Int. Cl. F21S 4/00

(52) U.S. Cl. 362/249.06

(57) ABSTRACT

A light-emitting element 1 is equipped with a large number of light-emitting diodes (3, 4, 5, 6) which are arranged in a housing 2 and serve as light-emitting means. Said light-emitting diodes run anti-parallel to one another, to be precise preferably in units (7, 8), which each have two diode pairs (9, 10) that run anti-parallel to one another.

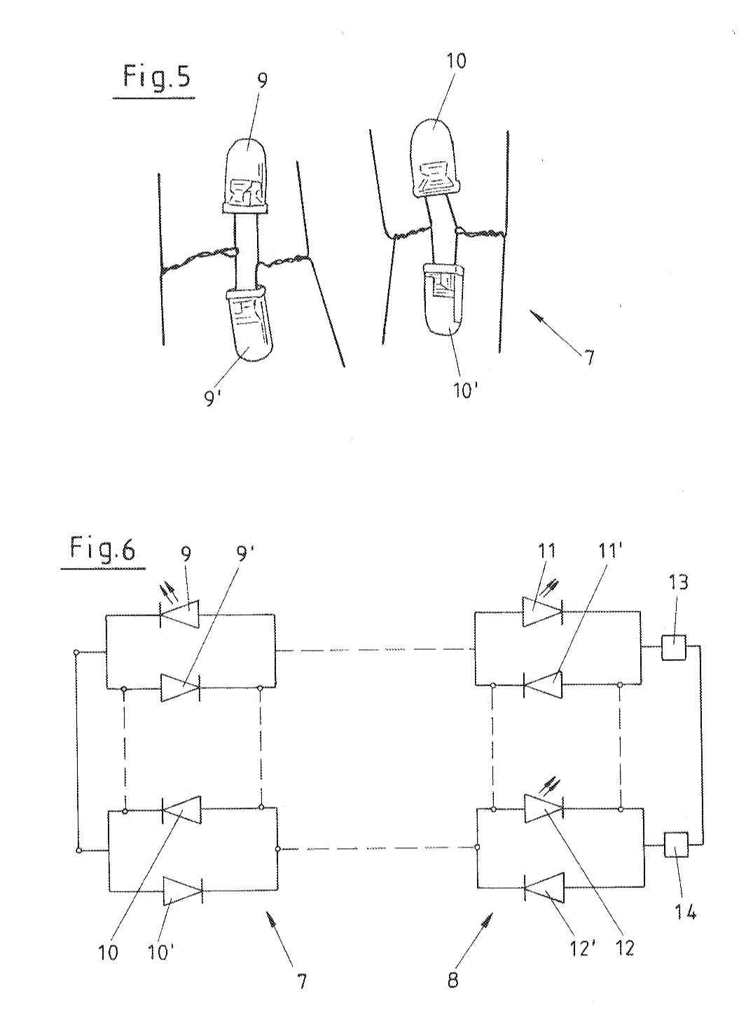

FIG. 5 is to be provided for publication.

The invention relates to a light-emitting element with a plurality of light-emitting diodes, which are arranged in a housing and serve as light-emitting means.

Increasingly, light bulbs and fluorescent tubes filled with noble gas are being replaced by light-emitting diodes, because these light-emitting diodes have a plurality of advantages. Light-emitting diodes are electronic semiconductor components that radiate when a current flows in forward direction through the diode. Light-emitting diodes then distinguish themselves by having numerous advantages compared to light bulbs and fluorescent tubes, which will further increase the expansion of the light-emitting diodes in the future. The application time of light-emitting diodes is thus unequally longer than with comparable light-emitting means, the lifetime is up to more than 100,000 hours for LEDs operated with correspondingly low currents. Compared with other light-emitting means, light-emitting diodes also develop far less temperature during operation, so that there is a great potential for energy saving to that effect as well. Furthermore, they are insensitive against shocks and they do not fail suddenly, but they only become weaker after a corresponding lifetime. Finally, also the characteristics of the light generated by light-emitting diodes can be very well varied, for instance with respect to the color of the emitted light. Besides the applications as status indicators for the operational readiness of electronic devices, the various advantages of the LEDs lead to an increased application in mobile light-emitting elements such as bicycles or in connection with areas that are only poorly illuminated or that need only minor lighting such as illuminated name tags, also increasingly in bundled form as complete light-emitting elements. Here, light bulbs, halogen lamps and other lamps are being replaced by a plurality of bundled light-emitting diodes. For instance, the document DE-OS 196 27 47 discloses a circuit assembly for signal transmitters to be used in traffic control systems with a group of LEDs that is connected anti-parallel to a second group of LEDs. This device however is only suitable for the application at a maximum of 40 Volt. Furthermore, transformers are forcibly provided, which are used to generate the alternating voltage and that convert a mains voltage of 230 Volt to a supply voltage between 10 and 40 Volt. The energy saving potentials that are achieved with this circuit assembly can by far not be viewed as sufficient.

It is the objective of the present invention to create a light-emitting element that enables the application of a plurality of light-emitting diodes in a suitable fashion and to make the application particularly effective, efficient, environmentally friendly, energy-efficient and safe.

This task is achieved in such a way that the light-emitting element is equipped with a plurality of anti-parallel arranged light-emitting diodes.

Through the application of the anti-parallel arranged light-emitting diodes in a light-emitting element, the advantages of light-emitting diodes can be utilized in a very suitable fashion. In that way, a light-emitting element with intelligent control is created that is distinguished by low power consumption, a long lifetime, no heat development and a security against deterioration, which is achieved in such a way that the diodes so to speak protect one another through their parallel arrangement in opposite direction.

In the simplest possible embodiment of the invention, it is thought that the light-emitting element are equipped with only four light-emitting diodes. These can be arranged in a row or in a star shape. Such a constellation of four is the preferred basic module for the following, yet to be introduced variants with a plurality of such units of four or more diodes. Factors such as the mains voltage, the mains frequency, the current/voltage ratio, the specific values of the respective LEDs, the manufacturer's specifications or the size and form of the light-emitting element can play a role for the determination of the number of diodes. Under consideration of the mains voltage, the optimal resistance—if necessary with the intended acceptance of a loss in quality—can then be calculated and the light-emitting element can be equipped with the corresponding number of LEDs depending on their current-voltage characteristic. In addition, the light-emitting element can be equipped with resistors.

In particular, it is thought that the light-emitting element is equipped with a plurality of units, where each has two anti-parallel diode pairs that are arranged to one another. Here, two pairs are circuited opposite to one another so that the diodes block each other. Through this arrangement resp. wiring of the individual light-emitting diodes, the application in almost any shape of light-emitting elements is also possible, because the combination of these pairs in a type of module can be realized in virtually any shape or size of light-emitting element with, in the end, any number of diodes. Through the connection of individual light-emitting diodes, an advantageous alternating voltage can be used, although light-emitting diodes usually can only be operated with direct voltage.

Also, in the event of failure of one of these diodes, the operation of the light-emitting element can virtually be continued without limitation, because a type of carry-over effect occurs thanks to the described circuit. This creates a failure protection, which also ensures the unrestricted operation of the light-emitting element in the event of numerous defective individual diodes.

In principle, it is considered that all diodes used in the light-emitting element are light-emitting diodes to ensure a corresponding brightness. But it is also conceivable that the light-emitting element has units that, besides the light-emitting diodes, are equipped with protective diodes. The latter variant is particularly used to be able to implement the described carry-over effect through a type of “failure diode”.

A preferred embodiment of the invention provides that the geometrical arrangement of the light-emitting diodes is tuned to the current flow to ensure the lowest possible resistance. Here, the geometrical arrangement of the diodes is geared towards the utilization of the current flow under the lowest possible resistance, in this case the passage to the reverse voltage. The effect of a strong increase of the current that is triggered when the reverse voltage has been reached shall in this way be utilized.

In the preferred embodiment, the units have two diode pairs that are arranged anti-parallel to one another. For the purpose of mechanical connection of these diodes, it is suggested that the units consist of diodes that are wired together. This applies also with respect to the carry-over effect and to ensure a good and secure connection of the diodes that are arranged in a star shape or the one behind the other.

In particular, it is provided for that the units consist of diodes, which are connected through twisted wiring. Due to the fact that the current always searches for the simplest path between the diodes, which is essential to the optimal operation of the light-emitting element, it is important to implement a particularly good connection, which can be realized the easiest through twisted wiring. Furthermore, thanks to the twisted wiring connection, a separate board is superfluous, which was up to now indispensable for corresponding light-emitting elements according to the prior art.

With the present light-emitting element, first effects can already be achieved when this element is equipped with at least eight units of two diode pairs each. Even with this comparatively low number of units, significant improvements can be achieved with regard to an extremely low power consumption. The same applies to the advantageous effect in form of secondary saving potentials, because the present light-emitting element does not generate heat, no idle current flows and no sparking occurs.

The described effects can be further increased if the light-emitting element is equipped with a number of units, which correspond to a multiple of 26.

These effects can be additionally increased if the light-emitting element is equipped with 30-70, preferably 40-60 units of two diode pairs each. Decisive for the determination of the number of diodes is an interaction of diode specific factors, especially the current-voltage characteristic and target settings of the manufacturer with regard to the light intensity, the energy consumption or the planned application time of the diodes. To achieve an optimal brightness in connection with a particularly good energy efficiency and a long lifetime of the light-emitting element, the ideal constellation is assumed to be 40-60 units with a mains voltage of a maximum of 250 Volt. If the voltage varies, an adaptation should be implemented through the resistance or through the diode pairs. Here, the breakdown voltage should be reached. Compared to previously known light-emitting elements of the same type, these values can be exceeded or fallen below by accepting losses in quality. Deviations are also possible with regard to the coloration or the size of the light-emitting element.

A particularly advantageous embodiment of the invention provides that the light-emitting element is equipped with at least 52 units of two diode pairs each, thus has 208 LEDs altogether. Here, the LEDs protect themselves from burning out, wherein additional resistors can be connected upstream, if necessary, for additional protection. 104 diodes each are actuated at the same time through one single voltage source. The functional principle is then based on a sine wave, whose half waves are divided in positive and negative as well as in four segments. Due to the periodical recurrence through the mains frequency, the upper and lower row of the light-emitting diodes arranged line by line lights respectively. Here, the human eye cannot perceive the loss in voltage due to the afterglow effect.

In connection with the particularly advantageous wiring resp. arrangement of the light-emitting diodes, it makes particular practical sense if the light-emitting element has a cylindrical shape. Therefore, the previously used fluorescent tubes, which were mostly filled with noble gas can be replaced. Retrofitting costs will also not occur, because all parts of the body are preserved. For the most, the starter must be removed. By means of standardized connection fittings, the light-emitting elements equipped with a plurality of anti-parallel connected tubular-shaped light-emitting diodes can be screwed resp. placed into the customary mountings. Compared to the conventional ones, the luminescent tubes according to the invention with the intelligent triggering system prove clearly superior with at least 400,000 operating hours. In addition, possible effects can be achieved with light-emitting diodes, e.g. as far as colored light is concerned. The units with two diode pairs, which are built comparatively very small, make it possible that with the arrangement according to the invention, light-emitting elements can be designed in the end in any length, width and depth, and in any desired shape, because the component made out of two diode pairs is built correspondingly small and can be combined in any possible way.

It must also be considered advantageous that in connection with the use of the light-emitting element according to the invention, some aggregates can be left out. However, it can be advisable that a micro controller is allocated to the light-emitting element, for instance to enable the selective triggering or to control the coloration of the LEDs.

Substantial power saving potentials also result from the fact that the light-emitting element is designed in that way that it can be connected directly, without the interconnection of an aggregate, to the mains alternating current. Here, the function of the light-emitting element is not depending on the voltage. Therefore, no upstream aggregate such as a power supply, a transformer or a rectifier is necessary, which in itself would already constitute a power consumer. At the same time, aggregate resp. assemblies such as frequency converter or compensators can be dropped. In addition, the light-emitting element according to the invention does not need a starting current, so that smaller cable cross sections can be realized with a corresponding economy in raw materials. The same applies for a board that is now superfluous, which has already been made reference to.

With the light-emitting element according to the invention and the arrangement and systematization of the LEDs, these LEDs are optimally protected. This applies especially with a forward voltage of approximately 4 V, wherein the operation is carried out with 2.7 to 3V. The reverse voltage lies at approx. 5 V.

Additional protection can be achieved through an upstream installation of at least two resistors of preferably 120 Ohm each. The upstream installation of a resistor seems already advantageous, when the light-emitting element according to the invention shall be operated in mains with diverging frequencies and mains voltages. Depending on the frequency in the mains, one or more resistors can be installed upstream.

The invention is particularly characterized in that a novel light-emitting element with intelligent control is provide, which distinguishes through a high and constant performance in connection with high energy saving potentials. For this purpose, a light-emitting element with preferably a total of 208 light-emitting diodes of, to the greatest extent possible, the same specification, which are connected in an anti-parallel manner, is suggested. Originating from the specific current-voltage characteristic of the LEDs, it can be selected, for light-emitting elements of various sizes and shapes, how many modules of four anti-parallel connected diodes should be used. This is carried out through coordination of the geometrical arrangement of the diodes to a current flow under the lowest possible resistance. In this way, the effect of a strong increase of the current that is triggered when the reverse voltage has been reached is utilized. In the pulsed arrangement, units are equipped with two diode pairs each that are arranged anti-parallel to one another. In this way, in the case of the connection of individudal light-emitting diodes, an alternating voltage can be used although light-emitting diodes usually can only be operated with direct voltage. Except for this preferred arrangement in units, there are virtually no limitations, i.e. for the light-emitting element as such, any kind of shape is possible, especially because the many units can be combined in virtually any way imaginable. This in turn has the advantage that luminescent tubes as a particularly common type of light-emitting elements can be equipped with the LEDs mounted according to the invention. The application of a luminescent tube with light-emitting diodes that are arranged according to the suggested wiring pattern is thus possible in customary mountings and a retrofitting is not necessary. In addition, certain optical effects can be realized with the light-emitting diodes, for instance with regard to the coloration, in a very easy way. The optimal energy saving potential becomes possible on one hand through the application of the light-emitting diodes as such, but also and in particular through the wiring pattern provided for. Furthermore, aggregates are left out, which are necessary as well as infamous as “power guzzlers” for fluorescent tubes used to date, such as power supplies, frequency converters, compensators or transformers. Through the intelligent triggering provided for, these aggregates are now superfluous. The light-emitting element according to the invention can be applied with a current voltage of up to 250 Volt and is also particularly safe in other regards. This way, there is no idle current, no sparking occurs, the light-emitting element is, independently of its design, shock resistant, not sensitive to vibrations and protected against splinters. No mercury is necessary for the manufacturing. The lifetime, up to 400,000 operating hours, ranks far beyond the light-emitting elements known to date. The quality of the light is then optimally uniform and bright.

Further details and single parts of the subject of the invention emerge from the following description of the relevant drawing, which shows a preferred exemplary embodiment with the necessary details and single parts. The Figures show as follows:

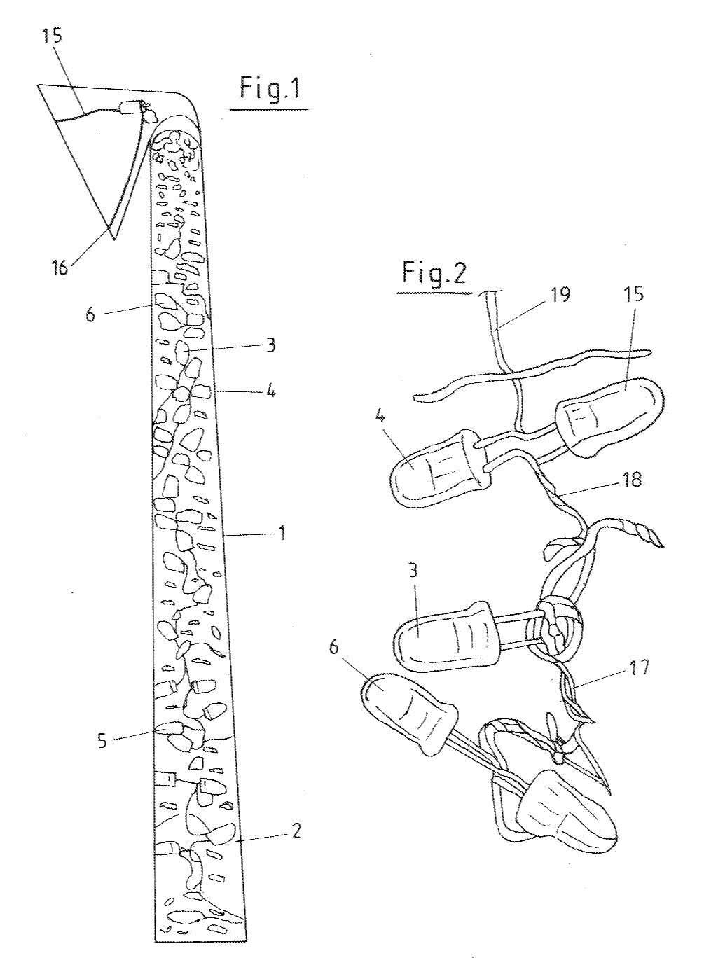

FIG. 1 a light-emitting element,

FIG. 2 a section of FIG. 1,

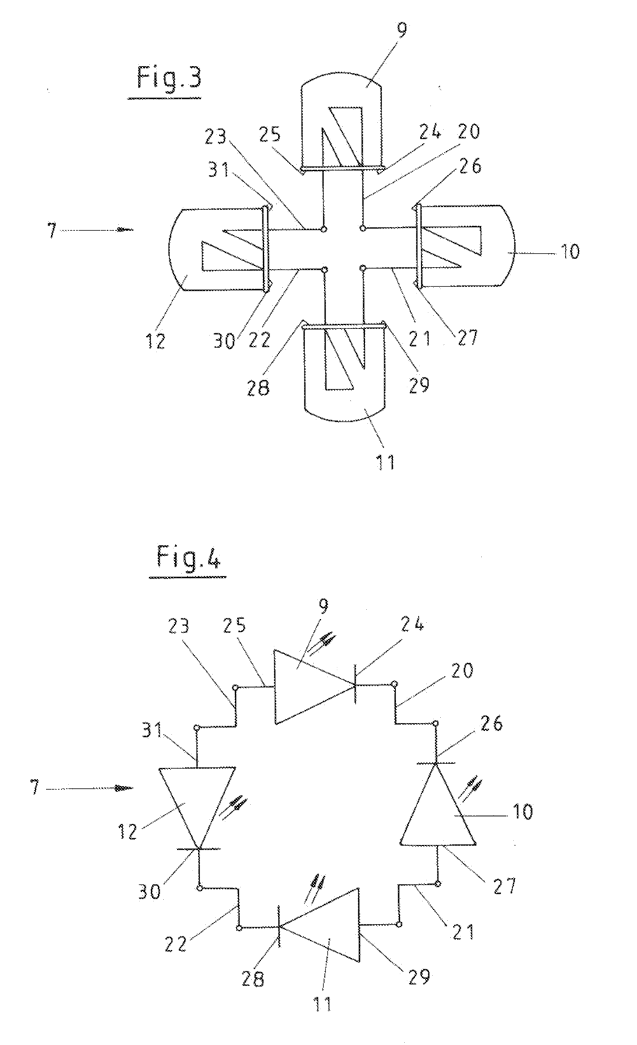

FIG. 3 a unit, consisting of two pairs of light-emitting diodes,

FIG. 4 a circuit diagram to FIG. 3

FIG. 5 two pairs of light-emitting diodes and

FIG. 6 a circuit diagram.

FIG. 1 displays a light-emitting element 1 in cylindrical shape. Its housing 2 is made of a transparent material, preferably glass or plastics and has in its interior a plurality of light-emitting diodes with, here, more or less random reference numbers 3, 4, 5, 6. It becomes apparent in this representation, in view of the plurality of light-emitting diodes 3, 4, 5, 6, etc., that virtually any shaping is possible for a light-emitting element with the wiring pattern according to the invention, because the light-emitting element 1 consists of a plurality of small units with light-emitting diodes. In the present example according to FIG. 1, a tubular housing 2, which additionally has the connections 15 and 16, is depicted.

FIG. 2 shows a section of FIG. 1 with again more or less random reference numbers 3, 4, 5, 6, for the light-emitting diodes, which are interconnected through wires 17, 18, 19.

FIG. 3 shows a unit 7 consisting of the diodes 9, 9′, 10, 10′, which unit is assembled from the two diode pairs 9, 9′, 10, 10′ arranged anti-parallel to one another. When equipping a light-emitting element with 52 units, thus altogether 208 light-emitting diodes, their application proved particularly advantageous. The wirings are marked with the reference numbers 20, 21, 22 and 23. The reference numbers 24, 26, 28 and 30 mark the cathodes, respectively, and the reference numbers 25, 27, 29 and 31 mark the anodes.

FIG. 4 shows the wiring diagram for this arrangement. The unit 7 with intelligent control consists of the diodes 9, 9′, 10, 10′ connected anti-parallel to one another with the wirings 20, 21, 22 and 23. The reference numbers 24, 26, 28 and 30 mark the cathodes, respectively, and the reference numbers 25, 27, 29 and 31 mark the anodes.

These diode pairs 9, 9′ and 10, 10′ are also shown individually in FIG. 5. In this form, the diode pairs are wired together.

Finally, FIG. 6 shows an additional wiring diagram with the four diode pairs 9, 9′, 10, 10′, 11, 11′ and 12, 12′. Here, the diodes 9, 9′ as well as 10, 10′ form the unit 7, the diodes 11, 11′ as well as 12, 12′ form unit 8. The resistors 13, 14 are installed upstream to the system to serve as an additional protection for the diodes from burning out.

1. A light-emitting element (1) with a plurality of light-emitting diodes (3, 4, 5, 6), which are arranged in a housing (2) and serve as light-emitting means, wherein the light-emitting element (1) is equipped with a plurality of anti-parallel arranged light-emitting diodes (3, 4, 5, 6).

2. The light-emitting element according to claim 1, wherein the light-emitting element (1) is equipped with at least four light-emitting diodes (3, 4, 5, 6).

3. The light-emitting element according to claim 1, wherein the light-emitting element (1) is equipped with a plurality of units (7, 8), which respectively have two diode pairs (9, 10) that are arranged anti-parallel to one another.

4. The light-emitting element according to claim 3, wherein the light-emitting element (1) has units (7, 8), which, besides the light-emitting diodes, are equipped with protective diodes.

5. The light-emitting element according to claim 3, wherein the geometrical arrangement of the light-emitting diodes (3, 4, 5, 6) is tuned to a current flow with the lowest possible resistance.

6. The light-emitting element according to claim 3, wherein the units (7, 8) consist of diodes (3, 4, 5, 6) that are wired together.

7. The light-emitting element according to claim 6, wherein the units (7, 8) consist of diodes (3, 4, 5, 6) that are connected with one another through twisted wiring.

8. The light-emitting element according to claim 1, wherein the light-emitting element (1) is equipped with at least eight units of two diode pairs (9, 10) each.

9. The light-emitting element according to claim 1, wherein the light-emitting element (1) is equipped with a number of units (7, 8), which correspond to a multiple of 26.

10. The light-emitting element according to claim 1, wherein the light-emitting element (1) is equipped with 40-60 units of two diode pairs (9, 10) each.

11. The light-emitting element according to claim 1, wherein the light-emitting element (1) is equipped with 52 units of two diode pairs (9, 10) each.

12. The light-emitting element according to claim 1, wherein the light-emitting element (1) has a cylindrical shape.

13. The light-emitting element according to claim 1, wherein a micro controller is allocated to the light-emitting element (1).

14. The light-emitting element according to claim 1, wherein the light-emitting element (1) can be connected directly, without the interconnection of an aggregate, to the mains alternating current.

15. The light-emitting element according to claim 1, characterized by a forward voltage of approximately 4 Volt.

16. The light-emitting element according to claim 1, characterized by a reverse voltage of approximately 5 Volt.

17. The light-emitting element according to claim 1, characterized by an upstream connection of at least two resistors.
